(19) United States
(12) Patent Application Publication
(10) Pub. No.: US 2016/0306781 A1
(43) Pub. Date: Oct. 20, 2016

(54) NON-DISRUPTIVE METHOD FOR PAGE RENDERING IN A PORTAL WHEN A PERFORMANCE CONSTRAINT IS NOT FULFILLED

(71) Applicant: International Business Machines Corporation, Armonk, NY (US)

(72) Inventors: Timo Kussmaul, Boeblingen (DE); Thomas Stober, Herrenberg (DE); Oliver Then, Aidlingen (DE)

(21) Appl. No.: 15/067,330

(22) Filed: Mar. 11, 2016

Related U.S. Application Data
(63) Continuation of application No. 14/690,608, filed on Apr. 20, 2015.

(51) Int. Cl. G06F 17/22

(52) U.S. Cl. CPC G06F 17/2247; G06F 17/2229; G06F 17/2235

(57) ABSTRACT

A method, a computer program product, and a computer system for page rendering in a portal. A computer processor determines whether the performance constraint for a portlet is fulfilled, in response to receiving a portlet request from a client. The computer processor determines whether there exists a page including the portlet, in response to determining that the performance constraint for the portlet is not fulfilled. The computer processor creates a new page to include the portlet, in response to determining that the page including the portlet does not exist. The computer processor creates a new link to the new page and renders a markup fragment including the new link to the new page.

### CROSS REFERENCE TO RELATED APPLICATION

This application is a Continuation Application of pending U.S. patent application Ser. No. 14/690,608 filed on Apr. 20, 2015.

### TECHNICAL FIELD OF THE INVENTION

The present invention relates generally to computer networks, and more particularly to non-disruptive method for page rendering in a portal when a performance constraint is not fulfilled.

### BACKGROUND

Customers have complained about missing portal functionality to control response times for portlet requests. There are currently two known solutions. One solution is parallel portlet rendering (PPR). PPR is not based on a Java EE standard conformant implementation for parallel processing of rendering requests. PPR provides a timeout functionality, i.e., a functionality to limit the maximum time for processing a rendering request. Another solution is portlet load monitoring (PLM). PLM detects unresponsive portlets by monitoring average response time and number of parallel requests. If the average response time or the number of requests exceeds thresholds defined for the portlet, the portal disables the portlet.

Both the solutions disrupt user's experience. For example, when a portlet becomes unresponsive (i.e., the response exceeds the defined response time limit), the solutions disable the portlet and render an error message. Thus, the user is not able to use the portlet anymore, even if the user chooses to accept a slow response time.

In addition, the root cause of a performance problem of a portlet is often a slow or irresponsive backend that the portlet interacts with. The current solutions are not able to represent the dependencies between portlets and backend services. Therefore, problematic backend behavior cannot be handled by the current solutions, e.g., by disabling a portlet depending on a performance indicator of a backend service.

### SUMMARY

In one aspect, a method for page rendering in a portal when a performance constraint is not fulfilled is provided. The method is implemented by a processor of computer device. The method includes determining whether the performance constraint for a portlet is fulfilled, in response to receiving a portlet request from a client. The method further includes determining whether there exists a page including the portlet, in response to determining that the performance constraint for the portlet is not fulfilled. The method further includes creating a new page to include the portlet, in response to determining that the page including the portlet does not exist. The method further includes creating a new link to the new page and rendering a markup fragment including the new link to the new page.

In another aspect, a computer program product for page rendering in a portal when a performance constraint is not fulfilled is provided. The computer program product comprises a computer readable storage medium having program code embodied therewith. The program code is executable to: determine whether the performance constraint for a portlet is fulfilled, in response to receiving a portlet request from a client; determine whether there exists a page including the portlet, in response to determining that the performance constraint for the portlet is not fulfilled; create a new page to include the portlet, in response to determining that the page including the portlet does not exist; create a new link to the new page; and render a markup fragment including the new link to the new page.

In yet another aspect, a computer system for page rendering in a portal when a performance constraint is not fulfilled is provided. The computer system comprises one or more processors, one or more computer readable tangible storage devices, and program instructions stored on at least one of the one or more computer readable tangible storage devices for execution by at least one of the one or more processors. The program instructions are executable determine whether the performance constraint for a portlet is fulfilled, in response to receiving a portlet request from a client. The program instructions are executable to determine whether there exists a page including the portlet, in response to determining that the performance constraint for the portlet is not fulfilled. The program instructions are executable to create a new page to include the portlet, in response to determining that the page including the portlet does not exist. The program instructions are executable to create a new link to the new page. The program instructions are executable to render a markup fragment including the new link to the new page.

### BRIEF DESCRIPTION OF THE SEVERAL VIEWS OF THE DRAWINGS

FIG. 1 is a diagram showing functional components of a portal, in accordance with one embodiment of the present invention.

FIG. 2(A) and FIG. 2(B) present a flowchart showing operational steps for page rendering in a portal, in accordance with one embodiment of the present invention.

FIG. 3 is a diagram illustrating components of a computer device hosting functional components of a portal shown in FIG. 1, in accordance with one embodiment of the present invention.

### DETAILED DESCRIPTION

In embodiments of the present invention, a method enables a portal to manage processing a portlet request when a certain performance constraint (e.g., responding time) is not fulfilled, in a flexible way without disrupting the user experience. For example, an administrator defines a performance constraint requiring that the maximum response time per portlet is 1.5 sec. During page rendering, the portal measures the time needed for rendering the portlet. If the rendering time exceeds the defined limit of the responding time, the portal does not render the portlet but moves the portlet to a newly generated page by automatically modifying a portal content model. Instead of rendering portlet markup, the portal renders an informational message and a new navigation path that links to the new page. The user is informed about why the portlet is removed and the user is able to use the navigation path to invoke the portlet if the user decides to accept the response time.

The method of the present invention improves user experience. The portal guarantees a defined performance (e.g. response time). For example, if there is a slow or unresponsive portlet (i.e. a portlet exceeds the defined performance constraint), the portal handles this situation automatically without disrupting the user experience. In the same example, the user is made aware of the longer response time of the portlet and is still able to use the portlet, if the user decides to accept the response time.

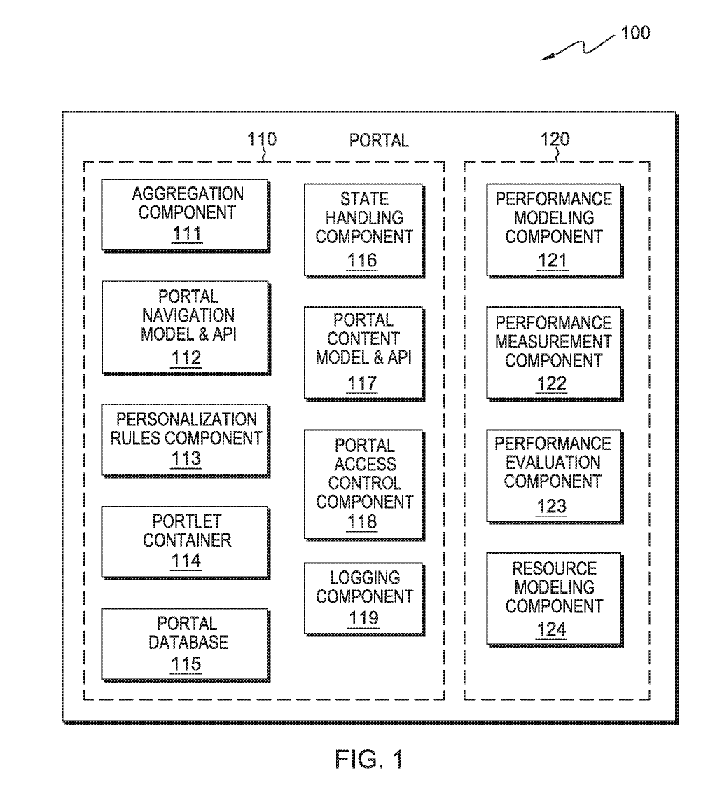

FIG. 1 is a diagram showing functional components of portal 100, in accordance with one embodiment of the present invention. Portal 100 comprises a first group of components, which is denoted by numeral 110, and a second group of components, which is denoted by numeral 120. The first group of components includes components of current portal technology, while the second group of components includes components proposed in the present invention. The first group of components includes aggregation component 111, portal navigation model & API 112, personalization rules component 113, portlet container 114, portal database 115, state handling component 116, portal content model & API 117, portal access control component 118, and logging component 119. Aggregation component 111 renders the portal pages. For this purpose, aggregation component 111 aggregates markup fragments of different portlets on the page, and it also generates additional markup fragments for, for example, the navigation paths, menus, headings, and any other page elements. Portal navigation model & API 112 manages the navigation model, i.e., the data to the navigation paths in the portal. Personalization rules component 113 is used to define and evaluate rules for personalizing the content of a page by including or excluding specific portlets or components in the page content, depending on a portal state of a current request. In current technology, personalization rules are typically defined manually by an administrator. Portlet container 114 runs portlets. For example, portlets are written in Java components; markup fragments (usually HTML fragments) can be placed on a portal page to deliver parts of the page. Portal database 115 stores data of the portal. State handling component 116 is invoked to determine a portal state for a current request. Portal content model & API 117 manages content models, i.e., information about how the pages are constructed. Portal access control component 118 manages access rights and controls access to all portal artifacts, especially on portal pages. Logging component 119 stores all user actions in the portal. From data of logging component 119, user behavior can be determined. Aggregation component 111 calls logging component 119 to save user actions (or events).

Referring to FIG. 1, the proposed components of the present invention (included in the second group of components denoted by numeral 120) include performance modeling component 121, performance measurement component 122, performance evaluation component 123, and resource modeling component 124.

Referring to FIG. 1, performance modeling component 121 creates and stores the data representing performance indicators in portal database 115. An administrator uses performance modeling component 121 to define a set of performance indicators. A performance indicator represents a certain performance metric of a portal resource such as a portlet or a non-portal resource. In one embodiment, a performance indicator may represent the response time of a web service. In another embodiment, a performance indicator may represent the CPU load that is induced by processing the web service response. In yet another embodiment, a performance indicator may represent the time required for rendering a portlet. The performance indicators need to be measureable and quantifiable. For example, a performance indicator may refer to a Java component which implements the functionality to measure a performance metric. In this case, performance indicator representation comprises the name of the Java class to be executed. In addition, a performance indicator may define a schedule which represents the interval the component should be invoked to measure the performance metric. Alternatively, the schedule may specify that the portlet indicator value should be measured for, for example, every portal request or every 100th portal request. The administrator uses the user interface of performance modeling component 121 to select the Java class and to define the schedule.

Using performance modeling component 121, the administrator associates one or multiple performance indicators with a portlet. Alternatively, the administrator associates one or multiple performance indicators with a resource. Thus, performance indicators are associated directly or indirectly (via resource modeling component 124) with portlets. Performance modeling component 121 stores the association in portal database 115.

The administrator defines a performance constraint relating to a performance indicator. The performance constraint may define a threshold value. The performance constraint will be fulfilled if the actual value of the related performance indicator lies below the threshold, e.g., a threshold value of 2 seconds for the performance indicator representing the response time of the web service. A performance constraint may be user-specific; for example, the threshold of 2 seconds for the performance indicator representing the response time is valid for some users such as non-administrator users, while a threshold of 5 seconds for the same performance indicator may be defined for other users such as administrators. A performance constraint may be portlet-specific; for example, the threshold for the web service may be 5 seconds for portlet A, while it may be 2 seconds for portlet B. In addition, a performance constraint may be portal state-specific. Portal state comprises all data that is used by the portal for processing the current request. The data comprises the request parameters, the requested portal page, the user subject, data about the client, and request headers sent by the client. A performance constraint may depend on the requested portal page. For example, if page A is requested, the performance constraint defines a threshold of 5 seconds; if page B is requested, the threshold is defined as 10 seconds. In addition, a performance constraint may represent a condition through a rule; for example, the performance constraint may define the following rule in pseudo code:

If (day is a weekend day) and (user is administer) and (performance
indicator value < 10 sec) then constraint is fulfilled
Else if (performance indicator value < 1.5 sec) then constraint is fulfilled
Else constraint is not fulfilled

Performance measurement component 122 determines values of the performance indicators. In an embodiment, performance measurement component 122 invokes the defined Java class according to the defined schedule and stores the values that are returned by the Java component. These values represents measured values of the performance indicators. Alternative to measuring the values, performance measurement component 122 may use a prediction algorithm or a machine learning functionality to predict the values of the performance indicators.

Performance evaluation component 123 retrieves a set of performance indicators that is associated with a portlet or with the resources that are related with the portlet. Performance evaluation component 123 also retrieves a set of performance constraints for the actual portal state. Performance evaluation component 123 invokes performance measurement component 122 to determine the actual value of the performance indicators. As described previously, performance measurement component 122 measures the performance indicator values. To determine whether the constraints are fulfilled, performance evaluation component 123 invokes the rules engine, passing the performance constraints as rules and the performance indicator values as rule parameters. The rules engine returns the result of rule evaluation: either successful (performance constraints are fulfilled) or not successful (performance constraints are not fulfilled). Performance evaluation component 123 returns the result to aggregation component 111.

Resource modeling component 124 is used by an administrator to create a representation of non-portal resources (such as REST (representational state transfer) APIs, web services, databases, servlet that are accessed over HTTP, etc) and to model their relations to portlets.

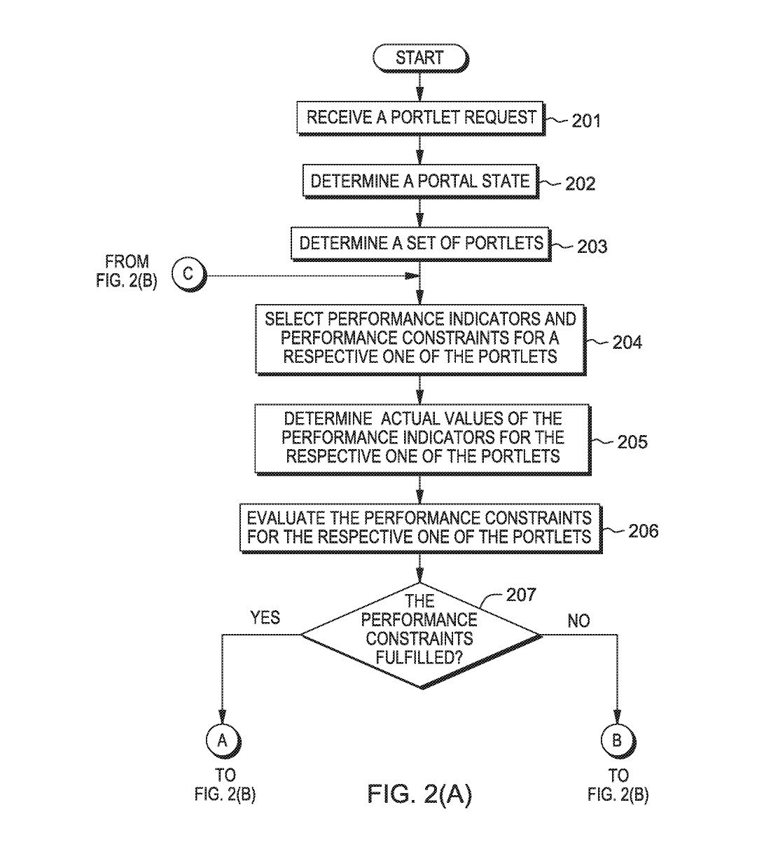

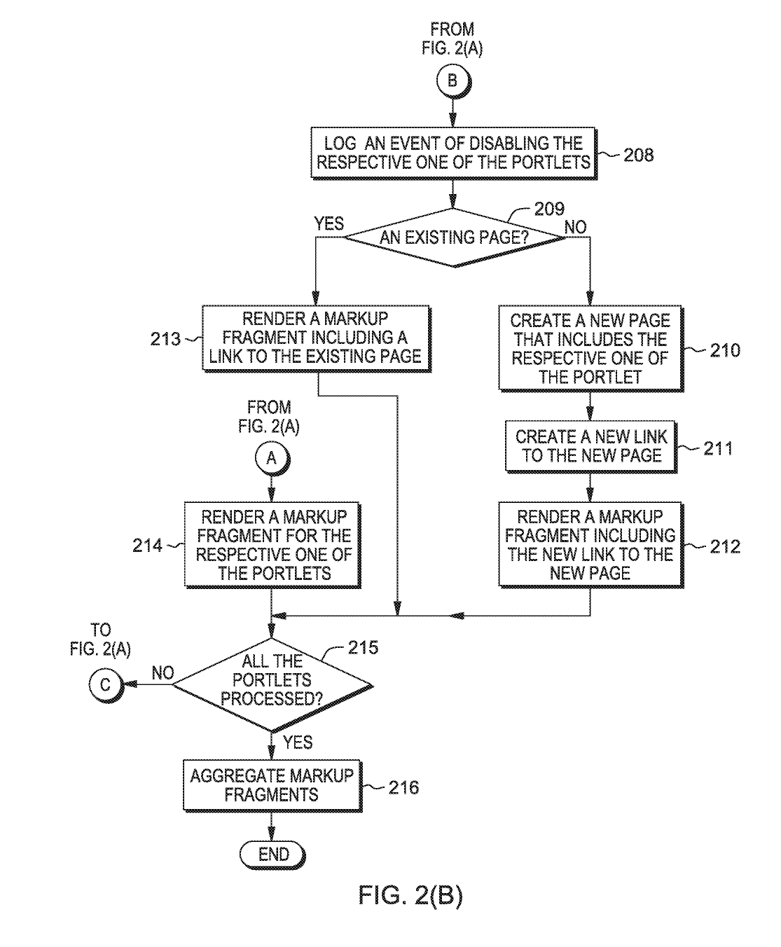

FIG. 2(A) and FIG. 2(B) present a flowchart showing operational steps for page rendering in portal 100, in accordance with one embodiment of the present invention. Referring to FIG. 2(A), at step 201, portal 100 receives a portlet request from a user. Generally, portal 100 receives and processes requests issued by clients (e.g. web browsers) on behalf of a user. At step 202, portal 100 determines a portal state. In one embodiment, aggregation component 111 receives the portlet request and invokes state handling component 116 to determine the portal state for the current portalet request. As discussed in a previous paragraph, the portal state typically comprises the requested portal page. At step 203, portal 100 determines a set of portlets that need to be invoked for processing the portlet request, depending on the portal state. In one embodiment, aggregation component 111 invokes portal content model & API 117 to retrieve the set of portlets (components) to be rendered.

Referring to FIG. 2(A), at step 204, portal 100 selects one or more performance indicators and one or more performance constraints for a respective one of the portlets. A performance indicator represents a certain performance metric of a portal resource such as a portlet or a non-portal resource; for example, it may represent the response time of a web service. In previous paragraph, the one or more performance indicators have been discussed in detail. A performance constraint may define a threshold value; for example, a performance constraint is a threshold value of a predetermined time period for the response time of the web service. In previous paragraph, the one or more performance constraints have been discussed in detail. In one embodiment, at this step, performance evaluation component 123 is invoked. At this step, performance evaluation component 123 retrieves the one or more performance indicators that is associated with the respective one of the portlets or with the resources that are related with the respective one of the portlets. Performance evaluation component 123 also retrieves the one or more performance constraints for the actual portal state.

Referring to FIG. 2(A), at step 205, portal 100 determines one or more actual values of the one or more performance indicators for the respective one of the portlets. In one embodiment, performance evaluation component 123 invokes performance measurement component 122 to determine the one or more actual values of the one or more performance indicators. The one or more actual values are determined by measurement or prediction. Performance measurement component 122 may measure the performance indicator values. Performance measurement component 122 invokes logging component 119 to store measured values in portal database 115. Performance measurement component 122 may also predict the performance indicator values. To predict a performance indicator value, performance measurement component 122 invokes a machine learning function to train and learn a prediction model for the performance indicator value, operating on the data from logging component 119. Performance measurement component 122 then invokes the machine learning component to predict the actual value for the current portal request based on the prediction model. The machine learning function returns the computed prediction result.

Referring to FIG. 2(A), at step 206, portal 100 evaluates the one or more performance constraints for the respective one of the portlets. In one embodiment, at this step, performance evaluation component 123 invokes the rules engine, passing the one or more performance constraints as rules and the performance indicator values as rule parameters. The rules engine returns the result of rule evaluation. The performance constraints are fulfilled if the one or more actual values of the one or more performance indicators, which are determined at step 205, lies below thresholds. For example, if the response time of the web service is below a threshold value of a predetermined time period, a performance constraint is fulfilled or satisfied.

Referring to FIG. 2(A), at decision block 207, portal 100 determines whether the one or more performance constraints are fulfilled or the one or more performance constraints are satisfied for the respective one of the portlets. In one embodiment, performance evaluation component 123 makes this determination. In response to determining that the one or more performance constraints are fulfilled or the one or more performance constraints are satisfied (YES branch of decision block 207), at step 214 shown in FIG. 2(B), portal 100 renders a makeup fragment for the respective one of the portlets. In one embodiment, aggregation component 111 invokes the respective one of the portlet in order to render the makeup fragment.

Referring to FIG. 2(B), at decision block 215, portal 100 determines whether all the portlets are processed. In one embodiment, performance evaluation component 123 makes this determination. In response to determining that all the portlets are processed (YES branch of decision block 215), at step 216, portal 100 aggregates all the makeup fragments. In one embodiment, aggregation component 111 creates a response including the markup fragments and returns this response to the client. In response to determining that not all the portlets are processed (NO branch of decision block 215), portal 100 reiterates steps starting from step 204 shown in FIG. 2(A). In a reiteration, another one of the portlets is processed. Through reiterations, all of the portlets are processes.

Precious paragraphs have described the steps for processing the portlets under the situation where the one or more performance constraints are fulfilled or satisfied. Now, the following paragraphs will discuss the steps for processing the portlets under the situation where the one or more performance constraints are not fulfilled or not satisfied.

In response to determining that the one or more performance constraints are not fulfilled or the one or more performance constraints are not satisfied for the respective one of the portlets (NO branch of decision block 207), at step 208 shown in FIG. 2(B), portal 100 logs an event of disabling the respective one of the portlets. In one embodiment, aggregation component 111 does not invoke the respective one of the portlets but logs data representing the event of disabling the respective one of the portlets. The log data includes the portlet identifier and the portlet state which further includes the page, the value of the performance indicators, and the identifier of any performance constraint that is not fulfilled.

Referring to FIG. 2(B), at decision block 209, portal 100 determines whether there is an existing page which has been created and contains the respective one of the portlets. In one embodiment, aggregation component 111 invokes portal content model & API 117 to make the determination. In response to determining that there is the existing page (YES branch of decision block 209, at step 213, portal 100 renders a markup fragment including a link to the existing page. Then, portal 100 processes decision block 215 to determine whether all the portlets are processed.

Referring to FIG. 2(B), in response to determining that there is not the existing page (NO branch of decision block 209), at step 210, portal 100 creates a new page that includes the respective one of the portlets. In one embodiment, aggregation component 111 invokes portal content model & API 117 to create and store the new page. At step 211, portal 100 creates a new link to the new page. At step 212, portal 100 renders a markup fragment including the new link to the new page. Then, portal 100 processes decision block 215 to determine whether all the portlets are processed.

In another embodiment, the content model change is made persistent by updating portal database 115. However, when performance measurement component 122 determines permanent improvement of performance indicator values after a portlet disabled, it enables the portlet again. To add the portlet to the page from which the portlet has been removed, performance measurement component 122 invoking portal content model & API 117.

In yet another embodiment, portal 100 uses personalization rules component 113 to disable portlets. Portal 100 processes the following steps for a portlet if the one or more performance constraints are not fulfilled or the one or more performance constraints are not satisfied (NO branch of decision block 207). After step 208 and decision block 209, in response to determining that there is not the existing page (NO branch of decision block 209), portal 100 processes step 210. Then, portal 100 creates or modifies a personalization rule, which excludes the portlet from portal content model & API 117 for the current portlet state. Portal 100 invokes a machine learning function to train/learn a classification model for the two classes of “enabled” and “disabled”. The machine learning function uses the logged data about disabled portlets as training data. The resulting classification model assigns input portal state either “disabled” or “enabled”. Portal 100 then translates the classification rules from the classification model into personalization rules, such that the personalization rules will exclude the portlet from the page content if the portlet is classified as disabled and it will include a portlet that renders at least a link to the newly created page. Portal 100 invokes personalization rules component 113 to store the personalization rule. For a subsequent request, portal 100 will invoke the personalization rule which is created from the current request.

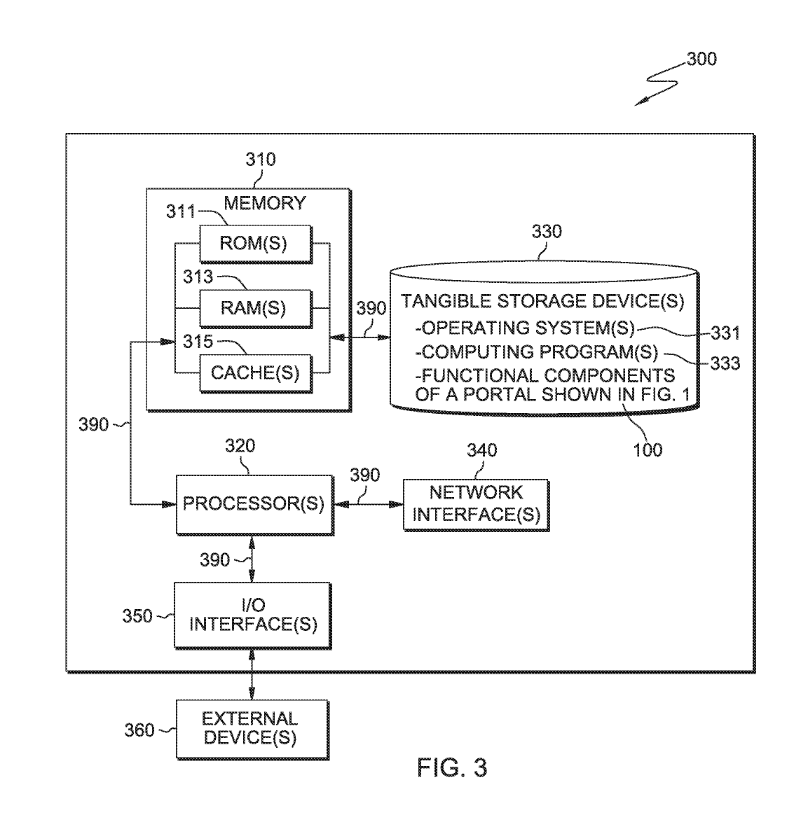

FIG. 3 is a diagram illustrating components of computer device 300 hosting functional components of a portal shown in FIG. 1, in accordance with one embodiment of the present invention. It should be appreciated that FIG. 3 provides only an illustration of one implementation and does not imply any limitations with regard to the environment in which different embodiments may be implemented.

Referring to FIG. 3, computer device 300 includes processor(s) 320, memory 310, tangible storage device(s) 330, network interface(s) 340, and I/O (input/output) interface(s) 350. In FIG. 3, communications among the above-mentioned components of computing device 300 are denoted by numeral 390. Memory 310 includes ROM(s) (Read Only Memory) 311, RAM(s) (Random Access Memory) 313, and cache(s) 315. One or more operating systems 331 and one or more computer programs 333 reside on one or more computer readable tangible storage device(s) 330. The functional components of a portal shown in FIG. 1 reside on one or more computer readable tangible storage device(s) 330. I/O interface(s) 350 allows for input and output of data with external device(s) 360 that may be connected to computing device 300. Network interface(s) 340 for communications between computing device 300 and a computer network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, and conventional procedural programming languages, such as the “C” programming language, or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field- programmable gate arrays (FPGA), or programmable logic arrays (PLA) may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the FIGs illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the FIGs. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer program product for page rendering in a portal when a performance constraint is not fulfilled, the computer program product comprising a computer readable storage medium having program code embodied therewith, the program code executable to:
determine whether the performance constraint for a portlet is fulfilled, in response to receiving a portlet request from a client;
determine whether there exists a page including the portlet, in response to determining that the performance constraint for the portlet is not fulfilled;
create a new page to include the portlet, in response to determining that the page including the portlet does not exist;
create a new link to the new page; and
render a markup fragment including the new link to the new page.

2. The computer program product of claim 1, further comprising the program code executable to:
create a markup fragment including a link to the page including the portlet, in response to determining that there exists the page including the portlet.

3. The computer program product of claim 1, further comprising the program code executable to:
select one or more performance indicators and one or more performance constraints for the portlet;
determine one or more actual values of the one or more performance indicators; and
evaluate the one or more performance constraints.

4. The computer program product of claim 3, wherein the one or more actual values of the performance indicators are measured by the portal.

5. The computer program product of claim 3, wherein the one or more actual values of the performance indicators are predicted by the portal.

6. The computer program product of claim 1, further comprising the program code executable to:
log an event of disabling the portlet, in response to determining that the performance constraint for the portlet is not fulfilled.

7. The computer program product of claim 1, further comprising the program code executable to:
create a personalization rule which excludes the portlet, in response to determining that the page including the portlet does not exist; and
use the personalization rule to a subsequent request for the portlet.

8. A computer system for page rendering in a portal when a performance constraint is not fulfilled, the computer system comprising:
one or more processors, one or more computer readable tangible storage devices, and program instructions stored on at least one of the one or more computer readable tangible storage devices for execution by at least one of the one or more processors, the program instructions executable to:
determine whether the performance constraint for a portlet is fulfilled, in response to receiving a portlet request from a client;
determine whether there exists a page including the portlet, in response to determining that the performance constraint for the portlet is not fulfilled;
create a new page to include the portlet, in response to determining that the page including the portlet does not exist;
create a new link to the new page; and
render a markup fragment including the new link to the new page.

9. The computer system of claim 8, further comprising the program instructions executable to:
create a markup fragment including a link to the page including the portlet, in response to determining that there exists the page including the portlet.

10. The computer system of claim 8, further comprising the program instructions executable to:
select one or more performance indicators and one or more performance constraints for the portlet;
determine one or more actual values of the one or more performance indicators; and
evaluate the one or more performance constraints.

11. The computer system of claim 10, wherein the one or more actual values of the performance indicators are measured by the portal.

12. The computer system of claim 10, wherein the one or more actual values of the performance indicators are predicted by the portal.

13. The computer system of claim 8, further comprising the program instructions executable to:
log an event of disabling the portlet, in response to determining that the performance constraint for the portlet is not fulfilled.

14. The computer system of claim 8, further comprising the program instructions executable to:
create a personalization rule which excludes the portlet, in response to determining that the page including the portlet does not exist; and
use the personalization rule to a subsequent request for the portlet.
